(19) United States
(12) Patent Application Publication
(10) Pub. No.: US 2023/0150860 A1
(43) Pub. Date: May 18, 2023

(54) TRANSPARENT B-QUARTZ GLASS-CERAMICS WITH SPECIFIC TRANSMISSION

(71) Applicant: Eurokera, Jouarre (FR)

(72) Inventors: Lionel Beunet, Fontainebleau (FR); Tiphaine Fevre, Paris (FR); Marie Comte, Fontenay Aux Roses (FR)

(73) Assignee: Eurokera, Jouarre (FR)

(21) Appl. No.: 17/920,647

(22) PCT Filed: May 6, 2021
(86) PCT No.: PCT/EP2021/062041

§ 371 Date: Oct. 21, 2022

(30) Foreign Application Priority Data
May 7, 2020 (FR) FR2004521

(51) Int. Cl. C03C 3/087; C03C 3/078; C03C 3/093; C03C 3/097

(52) U.S. Cl. CPC C03C 3/087; C03C 3/078; C03C 3/093; C03C 3/097

(57) ABSTRACT

The present invention relates to a transparent lithium aluminosilicate (LAS) glass-ceramic containing a β-quartz solid solution as the main crystalline phase, the composition of which, expressed in percentages by mass of oxides, contains 60 to 67.5% SiO₂, 18 to 22% Al₂O₃, 2.5 to 3.3% Li₂O, 0 to 1.5% MgO, 1 to 3.5% ZnO, 0 to 4% BaO, 0 to 4% SrO, 0 to 2% CaO, 3.1 to 5% TiO₂, 0.4 to 1.3% ZrO₂, 0 to 1% Na₂O, 0 to 1% K₂O, 0 to 5% P₂O₅, 0.02 to 0.1% CoO, 0.05 to 0.25% Fe₂O₃, with (0.74 MgO + 0.19 BaO + 0.29 SrO + 0.53 CaO + 0.48 Na₂O + 0.32 K₂O) / Li₂O < 0.8, and optionally up to 2% of at least one refining agent, the composition being free of V₂O₅ with the exception of unavoidable traces. It also relates to an article, consisting at least in part of a glass-ceramic, chosen in particular from a cooking plate and a glazing. It also relates to a lithium aluminosilicate glass, precursor of the glass-ceramic, and the process for producing the article.

### TECHNICAL FIELD

The context of the present application is that of transparent low-expansion lithium aluminosilicate (LAS) glass-ceramics containing a β-quartz solid solution as the main crystalline phase. More specifically, the present relates to:
transparent lithium aluminosilicate (LAS) glass-ceramics containing a β-quartz solid solution as the main crystalline phase, having a composition with a low lithium content and containing CoO and Fe₂O₃ as coloring agents but being free of V₂O₅ with the exception of the unavoidable traces so as to maintain a transmission adapted to allow the light emitted by white light-emitting diodes (LEDs) to pass through; said glass-ceramics being perfectly suitable as a constituent material of cooking plates associated with induction heating and possibly with radiant heating, in particular illuminated by white LEDs;
articles consisting, at least in part, of these glass-ceramics;
lithium aluminosilicate glasses, precursors of these glass-ceramics;
as well as a process for developing these articles.

### PRIOR ART

Transparent glass-ceramics — of the lithium aluminosilicate (LAS) type, containing a β-quartz solid solution as the main crystalline phase — have been in existence for more than 25 years. They have been described in numerous patent documents, including Patent US 5 070 045 and Patent Application WO 2012/156444. In particular, they are used as a constituent material for cooking plates, cooking utensils, microwave oven floors, chimney glass, chimney inserts, stove windows and oven doors (especially pyrolysis and catalytic), and fire protection glass.

In order to obtain such glass-ceramics (more precisely, to remove gaseous inclusions in the mass of the precursor molten glass), conventional refining agents, As₂O₃ and/or Sb₂O₃, have long been used. In view of the toxicity of these two elements and the increasingly strict regulations in force, it was decided to discontinue the use of these (toxic) refining agents in the manufacture of precursor glass. For environmental reasons, the use of halogens such as F and Br, which could have at least partly replaced the conventional refining agents As₂O₃ and Sb₂O₃, is also no longer desired. SnO₂ has been proposed as an alternative refining agent (see in particular the teaching from Patent Documents US 6 846 760, US 8 053 381, WO 2012/156444, US 9 051 209 and US 9 051 2010). It is increasingly being used. However, at a similar refining temperature, it is less efficient than As₂O₃. In general, and therefore particularly in the context of using SnO₂ as a refining agent, to facilitate refining, it is interesting to have glasses (precursors) with low viscosities at high temperature.

With reference to the heating means associated with such cooking plates (radiant heating means or induction heating means), the requirements as to the values of the coefficient of (linear) thermal expansion (CTE) of the material constituting said plates are more or less severe:
the plates used with radiant heaters can be brought to temperatures as high as 725° C. and, in order to resist the thermal shocks and thermal gradients which are created within them, their CTE is low, generally between ±10×10⁻⁷K⁻¹. When the main crystalline phase is a β-quartz solid solution the CTE is usually between ±3×10⁻⁷K⁻¹, between 25 and 700° C. A CTE in the ±6×10⁻⁷K⁻¹ range can however be still suitable ; Lithium is generally the key element which makes it possible to achieve these CTE values;
the plates used with conventional induction heaters are subjected to lower temperatures (temperatures only exceptionally reaching 450° C., generally a maximum of 400° C.). The thermal shocks, to which they are subjected, are therefore less violent; the CTE of said plates may be higher. Thus, a glass-ceramic with a CTE in the range ±14×10⁻⁷K⁻¹ between 25° C. and 700° C. can be used.

Currently, manufacturers are very commonly using the same types of glass-ceramics for these different types of heating. However, there is a need to have specific materials for the plates used with induction heaters which are becoming more and more popular. These developments are moving in two directions:
lower costs;
the need for materials with special optical transmission characteristics.

Lithium is one of the main constituents of these glass-ceramics (of the lithium aluminosilicate (LAS) type, transparent, containing a β-quartz solid solution as the main crystalline phase). At present, it is present in the composition of these glass-ceramics, generally at contents of 2.5 to 4.5%, more generally at contents of 3.6 to 4.0%, by mass (expressed as Li₂O). It acts essentially as a constituent of the β-quartz solid solution. It allows low or even zero CTE values to be obtained in glass-ceramics. It is a particularly effective melting agent for precursor glass (its impact can be measured especially on viscosity at high temperature). Today, the supply of lithium is more uncertain than in the past. In any case, this element is more expensive. The explanation for the recent pressure on the availability and price of lithium lies in the growing demand for lithium in the development of lithium batteries. It is therefore interesting to limit its content while retaining properties similar to precursor glasses in order to ensure compatibility with the manufacturing process and properties appropriate to glass-ceramics.

For aesthetic reasons, it is also desirable that the plates, even if transparent, do not show the elements that are placed underneath, such as the inductors, the electrical wiring and the control and monitoring circuits of the cooking device. An opacifier may be deposited on the underside of the plates or the material of which the plates are made may be strongly colored. In the latter case, a minimum level of transmission must still be maintained so that the display, indicated by light emitted by LEDs placed under the plate, is visible.

Glass-ceramics are generally colored with the help of V₂O₅ present in the constituent material: the resulting materials are very strongly colored and appear black in reflection and generally have a significant visible transmission (Y) (>5% for a 4 mm thick material) in the orange-red part of the visible spectrum (>600 nm). Consequently, these glass-ceramics are very well suited for red LEDs. However, blue and white LEDs are becoming increasingly popular and their use requires an adapted transmission curve of glass-ceramics.

The prior art has already described precursor glass-ceramics (of the lithium aluminosilicate (LAS) type, transparent, containing a β-quartz solid solution as the main crystalline phase) as well as the associated glass-ceramics, which have compositions with various lithium contents. For example:
Patent US 9 446 982 describes transparent colored lithium aluminosilicate (LAS) glass-ceramics containing a β-quartz solid solution as the main crystalline phase and having lithium contents (expressed as Li₂O) of 2 to less than 3% by mass (of at least 2% by mass, with reference to the crystallization management) and magnesium contents (expressed as MgO) of 1.56 to 3% by mass, with reference to the desired CTE value. CTE values between 10 and 25×10⁻⁷K⁻¹, between ambient temperature and 700° C., are sought for the glass-ceramics described, with reference to the technical problem of the compatibility of said glass-ceramics and their decoration;
Patent Application US 2015/0197444 describes transparent lithium aluminosilicate (LAS) glass-ceramics containing a β-quartz solid solution as the main crystalline phase and having a controlled transmission curve. The compositions described, which are free of As₂O₃ and Sb₂O₃, contain tin oxide (SnO₂) as the refining agent. They generally contain from 2.5 to 4.5% by weight of Li₂O. The exemplified compositions contain high levels of Li₂O, from 3.55% to 3.80% by mass;
Patent US 9 018 113 describes colored transparent glass-ceramics with an optimized transmission curve in the visible and infra-red range for use as cooking plates in combination with induction heating. Their composition contains from 1.5% to 4.2% by mass of Li₂O; the exemplified compositions all contain Li₂O contents higher than 2.9% by mass; the white LEDs′ transmission is not mentioned.
the Patent Application DE 10 2018 110 855 describes transparent glass-ceramics with a CTE of ±10×10⁻⁷K⁻¹ (between 20 and 700° C.), the composition of which contains 3.0 to 3.6% by weight of Li₂O (preferably 3.2 to 3.6% by weight of Li₂O) and, as dyes, V₂O₅ or MoO₃;
finally, Application FR18 60378 has shown that Li₂Ocontents in the range of 2 to 2.9% by weight are sufficient to obtain glass-ceramics with the required CTE value in the context of plates used with induction heating. However, as indicated above, V₂O₅ is always used as a coloring agent, when such a coloring agent is required.

The question of the transmission of light emitted by white or blue diodes has been addressed in several ways. The patents below present different solutions:
Patent EP2435378B2 describes glass-ceramics that transmit sufficiently between 450 and 480 nm to allow the transmission of light emitted by blue LEDs. These glass-ceramics contain CoO and V₂O₅ as coloring elements. White light transmission is not mentioned;
Patent US10415788B2 claims a glass-ceramic containing vanadium oxide whose optical spectrum allows the display of a dual emission band LED;
Patent US10575371B2 claims a cooking apparatus composed of heating elements, blue or white LEDs, a glass-ceramic colored by V₂O₅ displaying a visible integrated transmission between 2.3 and 40% and having a transmission greater than 0.6% between 420 and 480 nm and an opacifying layer on the underside. The presence of this layer makes the manufacturing process more complex and therefore more expensive;
Patent US9371977B2 claims an article with a color display area composed of a glass-ceramic (Y between 0.8 and 40% and Transmission > 0.1% between 420 and 780 nm), a light source and a filter. This device allows the display to be displayed in a color other than red. The presence of this filter makes the manufacturing process more complex and therefore more expensive;
Application DE102018110908 proposes colored transparent glass-ceramics with a transmission curve adapted to transmit without distortion the light emitted by white LEDs. This is achieved by adding MoO₃. This element is not at all common in glassware and the corresponding raw material is expensive. In order to provide the desired coloring, molybdenum must be in a reduced form in the glass-ceramic. Consequently, the coloring depends on the content of other elements that can interact with molybdenum (tin, vanadium, iron, etc.), and also on the melting, refining and heat treatment (known as “ceramming”) temperatures, which affect the redox state of the material;
Patent CN104609733 claims glass-ceramics free of vanadium oxide and compatible with blue, red and white LEDs. Coloring is obtained by adding CoO, NiO and Fe₂O₃. The compositions claimed contain a TiO₂ content between 2 and 3%. The coefficients of expansion reported for the examples are greater than 14×10⁻⁷K⁻¹.

### DISCLOSURE OF THE INVENTION

Therefore, there remains a need to find novel, inexpensive glass-ceramics that can be used as cooking plates in combination with induction heating, possibly with radiant heating, and that can let through the light of white LEDs. In order to facilitate the manufacturing process and to make it economical, it is desirable that the coloring of these new glass-ceramics should depend little or not at all on redox conditions and that the addition of reducing elements should be avoided, as well as the use of expensive raw materials. The use of MoO₃ is therefore not desirable. Similarly, the visibility of white light should be obtained without the addition of opacifiers or filters.

It is also highly desirable that the precursor glasses of said glass-ceramics should have properties similar to those of the precursor glasses of the glass-ceramics manufactured to date, so that the industrial process is very easily transposable.

FIG. 1 gives examples of the emission spectrum of commercial white LEDs. These spectra are characterized by two emission bands, one fairly intense between 430 and 480 nm and one less intense between 480 and 700 nm. Each LED is characterized by a color temperature that corresponds to the temperature at which the black body would have an emission of the same color. In a colorimetric diagram, the colors of the white LEDs are therefore close to the Planckian locus. (In the chromaticity diagram, the Planckian locus is a curve representing the colors of the black body as a function of its temperature. FIGS. 5 and 6 shows the Planckian locus in a CIExy chromaticity diagram.)

In order for the light emitted by the LED to appear white through the glass-ceramic plate, it is necessary that:
the glass-ceramic has significant transmission in this wavelength range (430 to 700 nm) and
that this transmission is uniform so that the color emitted by the diode is as little distorted as possible.

Since the transmission of a glass-ceramic cannot be perfectly constant throughout this wavelength range, it is desirable that, in order for the light emitted by the LED to appear white through the glass-ceramic, the transmission curve of the glass-ceramic should be such that the color of the LED seen through the plate is close to the Planckian locus.

The specifications for the glass-ceramics in question are set out below:
they must have a coefficient of thermal expansion (CTE) between ±14×10⁻⁷K⁻¹, between 25 and 700° C. (-14×10⁻⁷K⁻¹ ≤ CTE_{(25-700°c)} ≤ +14×10⁻⁷K⁻¹), advantageously between ±11×10⁻⁷K⁻¹ (-11×10⁻⁷K⁻¹ ≤ CTE_{(25-700°C)} ≤ +11×10⁻⁷K⁻ ¹), CTE_{(25-700°C)} therefore acceptable for use with conventional induction heating means (it is understood that said CTE_{(25-700°C)} is less than or equal to 14×10⁻⁷K⁻¹, advantageously less than or equal to 11×10⁻⁷K⁻¹), very advantageously less than or equal to 6×10⁻⁷K⁻¹ to be also usable with radiant heaters, and/or
at the thickness of use envisaged (plates typically 1 to 8 mm thick, more generally 2 to 5 mm thick and often 4 mm thick), said glass-ceramics must have an integrated visible transmission, Y (%), of at least 0.8% but less than 10%, advantageously at least 0.8% but less than 5%, very advantageously less than 2% in order to hide the elements under the cooking plate, and/or a percentage of diffusion (level of diffusion or “haze” (%)) less than 12%, advantageously less than 6%, more advantageously of 2%. At these levels, it has been checked experimentally that the diffusion has no significant impact on the visibility of the display units. Transmission measurements are carried out, for example, using a spectrophotometer equipped with an integrating sphere. From these measurements, the integrated transmission (Y (%)) in the visible range (between 380 and 780 nm) and the haze (%) are calculated according to ASTM D 1003-13 of 15 Apr. 2013 (under illuminant D65 with 2° observer), and/or
they must present in transmission colorimetric coordinates in CIExy space, for a D65 illuminant with a 2° observer, which are within the twelfth MacAdam ellipse having as its center the point with the following trichromatic coordinates x=0.44 y=0.38 Y=1.8%. It has been experimentally determined that the color of white LEDs, when viewed through glass-ceramics which exhibit this characteristic, is close to the Planckian locus; and/or
at the thickness of use envisaged (plates typically 1 to 8 mm thick, more generally 2 to 5 mm thick and often 4 mm thick), said glass-ceramics should preferably have an optical transmission for a wavelength of 950 nm (T₉₅₀ₙₘ) of between 40 and 70%, and even more preferably between 50 and 70%, which allows the use of infra-red electronic control keys, transmitting and receiving at this wavelength
have a precursor glass which has advantageous properties, or even the same advantageous properties as glasses (precursors of glass-ceramics of the prior art) containing a higher Li₂Ocontent; i.e.:
a) said precursor glass must have a low liquidus temperature (< 1400° C.) and/or a high liquidus viscosity (> 400 Pa.s, preferably > 700 Pa.s), which facilitates its forming; and/or, advantageously and,
b) said precursor glass must have a low viscosity at high temperature (T(30 Pa.s)≤ 1640° C., advantageously ≤ 1630° C.), which facilitates its refining.

It is furthermore highly desirable that said precursor glass can be transformed into glass-ceramic in a short time (< 3 hours) and that said precursor glass has an (electrical) resistivity, at a viscosity of 30 Pa.s, of less than 50 Ω.cm (preferably less than 20 Ω.cm). The person skilled in the art conceives (in consideration of the composition of glass-ceramics set out below) that obtaining this latter property, which is opportunely required for precursor glass, does not pose any particular difficulties.

The inventors have established the existence of glass-ceramics (of the lithium aluminosilicate (LAS) type, containing a β-quartz solid solution as the main crystalline phase), the composition of which therefore contains little lithium (maximum 3.3% by mass of Li₂O) and which meet the above specifications without the use of V₂O₅ as a coloring agent. This has been achieved by using a precise mixture of CoO, Fe₂O₃ and TiO₂. Indeed, the increase in TiO₂ content to the detriment of ZrO₂ allowed a significant decrease of transmission in the 550-650 nm range. Surprisingly, this significant decrease of transmission is only observed in glass-ceramics with limited Li₂Ocontent. The presence of CoO on its side makes possible to keep a sufficient transmission in the blue and that of Fe₂O₃ allows the decrease of the total transmission. The color of the glass-ceramics depends little on the redox state of the glass.

Said glass-ceramics constitute the first subject matter of the present application. Characteristically, these glass-ceramics have the following composition, expressed in percentages by weight of oxides:
60 to 67.5% SiO₂,
18 to 22% Al2O₃,
2.5 to 3.3% Li₂O,
0 to 1.5% MgO,
1 to 3.5% ZnO,
0 to 4% BaO,
0 to 4% SrO,
0 to 2% CaO,
3.1% to 5% TiO₂,
0.4 to 1.3% ZrO₂,
0 to 1% Na₂O,
0 to 1% K₂O,
0 to 3% P₂O₅,
0.02 to 0.1% CoO,
0.05 to 0.25% Fe₂O₃,
with (0.74 MgO + 0.19 BaO + 0.29 SrO + 0.53 CaO + 0.48 Na₂O + 0.32 K₂O) /
Li₂O< 0.8,
and optionally up to 2% of at least one refining agent,
the composition being free of V₂O₅ except for unavoidable traces.

In order to obtain a CTE in the +/- 6×10⁻⁷K⁻¹ range (25-700° C.) compatible with radiant heating, these glass-ceramics have the following preferred composition range for some of the elements, expressed in percentages by weight of oxides:
1.5 to 3% P₂O₅,
18 to 20% Al₂O₃,
2.7 to 3% Li₂O
with (0.74 MgO + 0.19 BaO + 0.29 SrO + 0.53 CaO + 0.48 Na₂O + 0.32 K₂O) /
Li₂O< 0.7.

With regard to each of the ingredients, entering (or likely to enter) in the indicated contents (the extreme values of each of the ranges indicated (main ranges and “sub-ranges”, advantageous, preferred: see above and below) forming an integral part of said ranges), in the composition indicated above, the following can be specified. For all intents and purposes, it is recalled that the percentages indicated are percentages by weight.

SiO₂ (60-67.5%): the SiO₂ content (≥ 60%) must be suitable for obtaining a precursor glass (of the glass-ceramic) of sufficient viscosity to guarantee a minimum viscosity value at the liquidus. The SiO₂ content is limited to 67.5%, since the higher the SiO₂ content, the higher the viscosity at high temperature of the glass and thus the more difficult it is to melt. Preferably, the SiO₂ content is between 60 and 66% (inclusive). More preferably, in particular in the absence of P₂O₅, the SiO₂ content is between 62 and 67.5% (inclusive), still more preferably between 62.5 and 66% (inclusive). Indeed when P₂O₅ is present, it is possible to use a lower amount of SiO₂, such as a SiO₂ content of between 60 and 62% (inclusive).

P₂O₅ (0-3%): this element may be present. To be effective, when it is present, it is generally at least 0.5%. Phosphorus can enter in the crystals of β-quartz solid solution. It contributes to obtain a low CTE. In an amount of at least 1.5 wt%, preferably 2%, it allows to reach CTE lower or equal to 6×10⁻⁷K⁻¹ (25-700° C. ). As a substitute for SiO₂, P₂O₅ makes it possible to lower the liquidus temperature, particularly in the case of a high ZnO content (i.e. > 2.5%). Advantageously, to obtain a significant effect on the liquidus temperature, P₂O₅ is present at a content between 1% and 3% (inclusive). In particular to obtain a CTE in the +/- 6×10⁻⁷K⁻¹ range (25-700° C.) compatible with radiant heating, P₂O₅ is present at a content between 1.5% and 3% (inclusive). However, when it is present in a too high amount, it has been observed that transmission increases. It may incidentally be noted that, in the absence of any addition of P₂O₅, it may be found in the composition of the glass (added as an impurity in at least one of the raw materials used or in the cullet (of glass and/or glass-ceramic) used), in trace amounts, generally in a maximum content of 1000 ppm (0.1%).

Al₂O₃ (18-22%): Al₂O₃ is a constituent of β-quartz crystals. Excessive amounts of Al₂O₃ (> 22%) make the composition more suitable for devitrification (into mullite or other crystals), which is undesirable. On the other hand, too small amounts of Al₂O₃ (< 18%) are unfavorable to nucleation and the formation of small β-quartz crystals. An Al₂O₃ content of 19% to 21% (inclusive) is advantageous. In glasses containing P₂O₅, the CTE decreases if the Al₂O₃ level decreases. Therefore in this case an Al₂O₃ content of 18% to 20% (inclusive) is advantageous, in particular to obtain a CTE in the +/- 6×10⁻⁷K⁻¹ range (25-700° C.) compatible with radiant heating.

Li₂O (2.5 - 3.3%): Li₂Ois one of the constituent elements of β-quartz crystals. Thermal expansion decreases as its content increases. If the Li₂O content is higher than 3.3%, the TiO₂-induced coloration is not sufficient and the transmission criteria are not met. It is easiest to meet the transmission criteria if Li₂Ois lower than 3%. For reasons of cost, a maximum content of 3% is also advantageous. However, a minimum content of 2.5 is necessary in order to maintain satisfactory CTE characteristics. In order to obtain a CTE in the +/-6×10⁻⁷K⁻¹ range (25-700° C.) compatible with radiant heating, an Li₂O content of 2.7% to 3% (inclusive) is advantageous, in particular in glasses containing P₂O₅.

In order to obtain a satisfactory CTE, the condition: (0.74 MgO + 0.19 BaO + 0.29 SrO + 0.53 CaO + 0.48 Na₂O + 0.32 K₂O) / Li₂O < 0.8 must also be met. In order to obtain a CTE in the +/- 6×10⁻⁷K⁻¹ range (25-700° C.) compatible with radiant heating, the condition (0.74 MgO + 0.19 BaO + 0.29 SrO + 0.53 CaO + 0.48 Na₂O + 0.32 K₂O) / Li₂O< 0.7 has to be met, in particular in glasses containing P₂O₅.

MgO (0-1.5%) and ZnO (1-3.5%): the inventors obtained the desired result by using ZnO and optionally also MgO in the amounts indicated. Magnesium and zinc can substitute for lithium in β-quartz solid solution crystals.

MgO (0-1.5%): this element may be present. To be effective, when it is present, it is generally at least 0.1%, in particular at least 0.3%. This element reduces the viscosity of the precursor glass at high temperature. It has less of an impact on devitrification than ZnO (see below) but it greatly increases the CTE of the glass-ceramic. For this reason its content, when present, is limited to 1.5%. When present, it is advantageously between 0.1% and 1.4% (inclusive), particularly between 0.1% and 1.37% (inclusive), more particularly between 0.1 and 1.35% (inclusive), even more particularly between 0.1% and 1.3% (inclusive). In any case, the condition (0.74 MgO + 0.19 BaO + 0.29 SrO + 0.53 CaO + 0.48 Na₂O + 0.32 K₂O) / Li₂O< 0.8 must be respected. In order to obtain a CTE in the +/- 6×10⁻⁷K⁻¹ range (25-700° C.) compatible with radiant heating, the condition: (0.74 MgO + 0.19 BaO + 0.29 SrO + 0.53 CaO + 0.48 Na₂O + 0.32 K₂O) / Li₂O< 0.7 has to be met, in particular in glasses containing P₂O₅.

ZnO (1-3.5%): this element also makes it possible to reduce the viscosity of the precursor glass at high temperature. Compared to Li₂O, it increases the CTE of the glass-ceramic, but this is moderate, which makes it possible to obtain glass-ceramics with CTEs lower than 14×10⁻⁷K⁻¹ between 25 and 700° C. In too large amounts, it causes unacceptable devitrification.

TiO₂ (3.1-5%): In addition to the effect on the transmission described above, TiO₂ allows nucleation in association with ZrO₂: these two elements allow the formation of a large number of nuclei and the formation of small size β-quartz crystallites. The formation of a large amount of β-quartz crystallites is key to obtaining the required CTE while the small size of the crystallites results in a transparent material. A too high TiO₂ content makes it difficult to obtain a transparent glass-ceramic because the transformation into β-spodumene becomes very fast and difficult to control and haze increases. Advantageously, the TiO₂ content is between 3.2 and 5% (inclusive)

ZrO₂ (0.4 - 1.3%): ZrO₂ must be present. The comparative example F shows the effect of the absence of this element. As indicated above ZrO₂, together with TiO₂, allows the nucleation of the precursor glass and the formation of a transparent glass-ceramic. The joint presence of the two elements allows an optimization of the nucleation. Due to the relatively low ZrO₂ content, relatively low liquidus temperatures (and high liquidus viscosity) are obtained, which is advantageous for manufacturing. In amounts of more than 1.3% the transmission of the glass-ceramic becomes too high and its color unacceptable. In too large amounts, ZrO₂ also leads to unacceptable devitrification. ZrO₂ is advantageously present at a content between 0.4 wt% and 1.3% (inclusive), very advantageously present at a content between 0.5 wt% and 1.3% (inclusive), in particular present at a content between 0.5 wt% and 1% (inclusive).

BaO (0-4%), SrO (0-4%), CaO (0-2%), Na₂O (0-1%) and K₂O (0-1%):
these elements are optionally present. To be effective, each of these elements, when present, is generally present at at least 1000 ppm (0.1%). These elements remain in the residual glass of the glass-ceramic. They decrease the viscosity of the precursor glass at high temperature, facilitate dissolution of ZrO₂ and limit devitrification in mullite, but increase the CTE of glass-ceramics. This is why the condition:
(0.74 MgO + 0.19 BaO + 0.29 SrO + 0.53 CaO + 0.48 Na₂O + 0.32 K₂O) / Li₂O < 0.8 must be respected to have a sufficiently low CTE. Moreover in order to obtain a CTE in the +/- 6×10⁻⁷K⁻¹ range (25-700° C.) compatible with radiant heating, the condition: (0.74 MgO + 0.19 BaO + 0.29 SrO + 0.53 CaO + 0.48 Na₂O + 0.32 K₂O) / Li₂O< 0.7 has to be met, in particular in glasses containing P₂O₅.

It can be noted that SrO is generally not present as an added raw material. In such a context (of SrO not present as an added raw material), if SrO is present, it is only in unavoidable trace amounts (< 100 ppm), brought as an impurity in at least one of the raw materials used or in the cullet (of glass and/or glass-ceramic) used.

Coloring agents: the required transmission has been obtained by adding CoO (0.02 - 0.1% inclusive) and Fe₂O₃ (0.05% - 0.25% inclusive, advantageously 0.05 - 0.15% inclusive). CoO allows getting the required transmission in the blue while Fe₂O₃ tends to decrease the overall transmission and to give a yellow/orange hue. The person skilled in the art will know how to adjust the respective amounts of CoO and Fe₂O₃ to optimize the transmission and the color of the glass-ceramic.

Other coloring agents can be added such as oxides of transition elements or rare earth elements (NiO, Nd₂O₃, Er₂O₃, etc.). Advantageously the presence of NiO is excluded, except for the inevitable impurities. However, the composition of glass-ceramics is free of V₂O₅ (apart from unavoidable impurities, maximum 30 ppm). Indeed, vanadium oxide leads to a very asymmetrical absorption in the visible range (strong absorption between 400 and 550 nm and very weak above 550 nm) which is very disadvantageous for the intended application. It is also preferable not to use chromium oxide which leads to strong absorption between 400 and 450 nm. This is shown in the comparative example A. Advantageously the presence of MoO₃ is excluded, except for the inevitable impurities (maximum 100 ppm).

Among the coloring agents, Fe₂O₃ has a special place. It has an effect on the color and is in fact often present, in greater or lesser amounts, as an impurity (for example from raw materials). However, it is not impossible to add more of it to adjust the color. Its permitted presence “in significant amount” in the composition of the glass-ceramics of the present application allows the use of less pure and therefore often cheaper raw materials.

The addition of these coloring elements makes it possible to meet the specifications with reference to the following requirements (formulated for the thickness of use, typically from 1 to 8 mm, more generally from 2 to 5 mm and often 4 mm):
have an integrated transmission (Y) of at least 0.8% but less than 10%, advantageously at least 0.8% but less than 5%, very advantageously at least 0.8% but less than 2%, in order to hide the elements under the cooking plate;
have a diffusion percentage (diffusion or “haze” (%)) of less than 12%, advantageously less than 6%, more advantageously less than 2%;
have colorimetric coordinates in the CIExy space measured in transmission, for an illuminant D65 with a 2° observer, which are comprised within the twelfth MacAdam ellipse having as its center the point having the following trichromatic coordinates x=0.44 y=0.38 Y=1.8%. It has been experimentally determined that the color of white LEDs, when viewed through glass-ceramics which have this characteristic, is close to the Planckian locus. The coordinates of this ellipse were obtained according to the article “Specification of Small Chromaticity Differences” of David L. MacAdam, J.O.S.A. (43) pages 18 and following (1943).

The elements of this ellipse are a (half major axis): 0.0074, b (half minor axis): 0.00134 and θ (orientation): 48.39°. If a commercial LED is used (for example, the TC lite LED marketed by the EGO company), it can be seen that the glass-ceramics of the invention allow a white color to be seen. If the trichromatic coordinates are measured using this LED as illuminant, the colors obtained are indeed close to the Planckian locus.

- while keeping preferably an optical transmission for a wavelength of 950 nm T₉₅₀ₙₘ between 40 and 70%, preferably between 50 and 70%, which allows the use of infra-red electronic control keys, emitting and receiving at this wavelength.

Refining agent(s): The glass-ceramics of the present application advantageously contain at least one refining agent, such as As₂O₃, Sb₂O₃, SnO₂, CeO₂, a chloride, a fluoride or a mixture thereof. Said at least one refining agent is present in an effective amount (to provide chemical refining), conventionally not exceeding 2% by mass. It is thus generally present between 0.05% and 2% by mass (inclusive). Preferably, for environmental reasons, the refining is obtained using SnO₂, generally from 0.05% to 0.6% (inclusive) by mass of SnO₂ and, more particularly, from 0.15% to 0.4% (inclusive) by mass of SnO₂. In this case, the glass-ceramics in this submission do not contain As₂O₃ or Sb₂O₃, or contain only unavoidable traces of at least one of these toxic compounds (As₂O₃ + Sb₂O₃ < 1000 ppm). If traces of at least one of these compounds are present, it is as a contaminant; this is due, for example, to the presence, in the vitrifiable raw material feedstock, of recycled materials such as cullet (from old glass and/or old glass-ceramics refined with these compounds). In this case, the co-presence of at least one other refining agent, such as CeO₂, a chloride and/or a fluoride is not excluded but, preferably, SnOₛ is used as the sole refining agent.

It should be noted that the absence of an effective amount of chemical refining agent(s), or even the absence of any chemical refining agent, is not totally excluded; the refining process is then carried out thermally. This non-excluded variant is by no means preferred.

With regard to the condition to be met: the ratio (0.74 MgO + 0.19 BaO + 0.29 SrO + 0.53 CaO + 0.48 Na₂O + 0.32 K₂O) / Li₂O < 0.8, i.e. essentially with reference to the CTE of the glass-ceramic, it is understood that the elements of the sum of the numerator have been weighted according to their molar mass in view of the denominator reduced to one mole of Li₂O. It should be noted that the contents of the oxides are expressed as percentages by mass.

The ingredients, which are or may be used in the composition of the glass-ceramics of the present application, identified above (SiO₂, P₂O₅, Al₂O₃, Li₂O, MgO, ZnO, TiO₂, ZrO₂, BaO, SrO, CaO, Na₂O, K₂O, Fe₂O₃, CoO, refining agent(s) and other coloring agent(s)), may well represent 100% by mass of the composition of the glass-ceramics of the present application but the presence of at least one other compound, in small amounts (generally less than or equal to 3% by mass), which does not substantially affect the properties of the glass-ceramics, cannot a priori be totally excluded. In particular, the following compounds may be present, in a total content less than or equal to 3% by mass, each of them in a content less than or equal to 2% by mass: B₂O₃, Nb₂O₅, Ta₂O₅, and WO₃. For B₂O₃, it is therefore optionally present (0-2%). In order to be effective, in particular to improve the fusibility of the precursor glass, it is generally present at least 0.5%. More generally, it is present at 0.5 to 1.5%. However, in fact, B₂O₃ is rarely present as an added raw material, and is generally present only in trace amounts (less than 0.1%). Indeed, B₂O₃ promotes the formation of β-spodumene and the appearance of haze. Thus, the composition of the glass-ceramics of the present application is advantageously free, except for unavoidable traces, of B₂O₃.

The ingredients, which are or may be used in the composition of the glass-ceramics of the present application, identified above (SiO₂, P₂O₅, Al₂O₃, Li₂O, MgO, ZnO, TiO₂, ZrO₂, BaO, SrO, CaO, Na₂O, K₂O, Fe₂O₃, CoO, refining agent(s) and other coloring agent(s)), therefore represent at least 97% by mass, or at least 98% by mass, or at least 99% by mass, or even 100% by mass (see above) of the composition of the glass-ceramics of the present application.

The glass-ceramics of the present application therefore contain SiO₂, Al₂O₃, Li₂O, ZnO, MgO and P₂O₅ as essential constituents of the β-quartz solid solution (see below). This β-quartz solid solution represents the main crystalline phase. This β-quartz solid solution generally accounts for more than 80% by mass of the total crystallized fraction. It generally represents more than 85% by mass of said total crystallized fraction.

The glass-ceramic may contain other crystalline phases in low concentrations. For example:

β-Spodumene. In an amount greater than 8% by mass of said total crystallized fraction, it leads to unacceptable haze.

Spinel solid solutions. The formation of these phases is favored by the relatively high contents of ZnO and TiO₂. In amounts greater than 10% by mass of said total crystallized fraction, they lead to unacceptable expansion. In small amounts, they could favor the obtaining of a satisfactory color.

The glass-ceramics of the present application also contain about 20% to about 50%, preferably about 20% to about 45% by mass of residual glass. Too much residual glass leads to unacceptable coefficient of thermal expansion..

The glass-ceramics of the present application therefore have a coefficient of thermal expansion (CTE) between ±14×10⁻⁷K⁻¹, advantageously between ±11×10⁻⁷K⁻¹, very advantageously between ±6×10⁻⁷K⁻¹ between 25 and 700° C., (see above).

The second subject matter of the present application relates to articles consisting, at least in part, of a glass-ceramic of the present application as described above. Said articles may consist entirely of a glass-ceramic of the present application. Said articles advantageously consist of cooking plates, colored in their mass (see above). However, their use is not limited to this single application. In particular, they can also be used as a material for glazing, cooking utensils, microwave oven floors, oven doors, etc., which are colored. It is of course understood that the glass-ceramics of the present application are logically used in contexts compatible with their CTE. Thus, the cooking plates of the present application are strongly (suitable and) recommended for use with induction heating means and, if CTE ±6×10⁻⁷K⁻¹ between 25 and 700° C., with radiant heating means.

The third subject matter of the present application relates to the use of a glass-ceramic of the present application, as a substrate for an element selected from a cooking plate and glazing, in particular for cooking utensils, microwave oven floors, oven doors, colored. More particularly it is a substrate of a cooking plate, even more particularly suitable for use with induction heating means and, if CTE ±6×10⁻⁷K⁻¹ between 25 and 700° C., with radiant heating means.

The fourth subject matter of the present application relates to lithium aluminosilicate glasses, the precursors of the glass-ceramics of the present application, as described above. Said glasses have a characteristic composition which makes it possible to obtain said glass-ceramics. The glasses of the present application are obtained, in the conventional way, by melting a feedstock of vitrifiable raw materials (raw materials, present in the appropriate proportions). However, it is conceivable (and this will not surprise the skilled craftsman) that the batch in question may contain glass or glass-ceramic cullet. Said glasses are of particular interest in that:
they have interesting devitrification properties, particularly compatible with the implementation of forming processes by lamination, floatation and pressing. Said glasses have a low liquidus temperature (< 1400° C.) and a high liquidus viscosity (> 400 Pa.s, preferably > 700 Pa.s); and/or, advantageously and,
they have a low viscosity at high temperature (T(30 Pa.s)≤ 1640° C., advantageously ≤ 1630° C.),
it is possible to obtain (from said precursor glasses) the glass-ceramics of the present application by implementing thermal crystallization cycles (called ceramming cycles) of short duration (< 3 h), or even of very short duration (< 1 h).

It should also be noted that the resistivity of said precursor glasses is low (resistivity less than 50 Ω.cm, preferably less than 20 Ω.cm, at a viscosity of 30 Pa.s).

Particular emphasis is placed on low liquidus temperature, high liquidus viscosity and low viscosity at high temperature (see above).

The last subject matter of the present application relates to a process for producing an article consisting at least in part of a glass-ceramic as described above.

Said process is a process by analogy.

Conventionally, said process comprises heat treatment of a vitrifiable raw material batch (it is understood that such a vitrifiable batch may contain glass and/or glass-ceramic cullet (see above)) under conditions which ensure successive melting and fining, followed by forming the fined molten precursor glass (said forming being for example carried out by rolling, pressing or floatation) and then by a heat treatment to obtain partial crystallization of the fined and formed molten precursor glass (ceramming), the ceramming temperature being generally at most 920° C., in particular at most 900° C. Due to the increase in TiO₂ to the detriment of ZrO₂, the material has a tendency to be hazier during the heat treatment because it rapidly transforms into a β-spodumene. It is therefore necessary to control closely the maximum ceramming temperature.

Refining is generally carried out at a temperature above 1600° C.

The ceramming heat treatment generally consists of two steps: a nucleation step and another step to grow the crystals of the β-quartz solid solution. Nucleation generally takes place in a temperature range of 650-820° C. and crystal growth in a temperature range of 850 -920° C., in particular 850-900° C. As to the duration of each of these steps, one can indicate, by no means restrictively, about 5 to 60 min for nucleation and about 5 to 30 min for crystal growth. The person skilled in the art knows how to optimize, with particular reference to the transparency required, the temperatures and durations of these two stages according to the composition of the precursor glasses.

Said process for producing an article, consisting at least in part of a glass-ceramic of the present application, thus comprises successively:
melting a vitrifiable batch, followed by refining the resulting molten glass;
cooling the refined molten glass obtained and simultaneously forming it to the desired shape for the article; and
ceramming heat treatment of said shaped glass, the ceramming temperature being preferably at most 900° C.

The two successive steps of obtaining a shaped refined glass (precursor of glass-ceramics) and of ceramming of said shaped refined glass can be carried out one after the other or staggered in time (on the same site or on different sites).

Characteristically, the vitrifiable raw material feedstock has a composition which makes it possible to obtain a glass-ceramic of the present application, thus having the mass composition indicated above (containing advantageously (in the absence of As₂O₃ and Sb₂O₃ (see above)) SnO₂ as refining agent, very advantageously as the sole refining agent (generally from 0.05% to 0.6% (inclusive) by mass of SnO₂ and, more particularly, from 0.15% to 0.4% (inclusive) by mass of SnO₂). The ceramming applied to glass obtained from such a batch is quite conventional. It has already been mentioned that said ceramming can be obtained in a short time (< 3 hours), or even very short (< 1 hour).

In the context of producing an article, such as a cooking plate, the precursor glass is cut after shaping, before undergoing the ceramming heat treatment (the ceramming cycle). It is usually also shaped and decorated. Such shaping and decorating steps can be carried out before or after the ceramming heat treatment. Decoration can, for example, be done by screen printing.

It is now proposed to illustrate the present application with the following examples and comparative examples. Although the examples below describe only laboratory experiments, the characteristics of glass and glass-ceramics that are given show that these materials can be produced on an industrial scale. For examples, the glasses described as examples have been melted in electrical furnace and therefore display a relatively low OH content. It is known that melting using air-gas or oxy-gas burners, as it is commonly done in production tanks, will increase the OH content of the glass. That could change slightly the glass and glass-ceramic properties. However a person skilled in the art will know how to adjust the composition and the ceramming in order to obtain the required properties.

### BRIEF DESCRIPTION OF THE DRAWINGS

FIG. 1 shows the emission spectrum of two commercial white LEDs (EGO Flex TC and EGO Lite TC) (radiation/nm as a function of the wavelength in nm).

FIG. 2 shows the transmission curves in % as a function of the wavelength in nm of a glass-ceramic according to the invention (Example 1) and of commercially available glass-ceramics (Kerablack® Plus and KeraVision®) with a thickness of 4 mm.

FIGS. 3 and 4 show the colorimetric coordinates y as a function of x according to the CIE 1931 - D65 diagram of glass-ceramics according to the invention (examples 1 to 25) of commercially available glass-ceramics (Kerablack® Plus and KeraVision®) and of comparative examples A, B, C, D and E.

FIGS. 5 and 6 show in a CIE 1931 - D65 diagram the Planckian locus and the color coordinates (x, y) of the preferred examples of the invention measured with the EGO Lite TC LED as illuminant.

### EXAMPLES

Process for producing glasses: One-kilogram batches of raw materials were prepared. The raw materials, in the proportions (proportions expressed in % by mass of oxides) reported in the first part of the tables, were carefully mixed. The mixtures were placed in platinum crucibles for melting. The crucibles containing said mixtures were then placed in a furnace preheated to 1550° C. This furnace is heated with MoSi electrodes. The crucibles have undergone in said furnace a melting cycle of the following type:
holding, for 30 min, at 1550° C.,
temperature rise from 1550° C. to 1650° C. in 1 h, and
holding for 5.5 h at 1650° C.

The crucibles were then taken out of the furnace and the molten glass poured onto a preheated steel plate. It was rolled to a thickness of 6 mm. Glass plates were thus obtained. They were annealed at 650° C. for 1 hour and then gently cooled.

The results obtained in this way at the laboratory scale are completely transposable to the industrial scale.

Properties: The properties of the glass obtained are indicated in the second part of the tables below.

T_{liq} (°C) is the temperature of the liquidus. In fact, the liquidus is given by a range of temperatures and associated viscosities: the highest temperature corresponds to the minimum temperature at which no crystals were experimentally observed, the lowest temperature to the maximum temperature at which crystals were experimentally observed. The experiments were carried out on volumes of precursor glass of about 0.5 cm³, maintained for 17 h at the test temperature and quickly cooled to room temperature. Observations were made by optical microscopy.

The viscosities were measured with a rotational viscometer. T(30 Pa.s) (°C) corresponds to the temperature at which the viscosity of the glass was 30 Pa.s (= 300 poise). Using these viscosity data and the minimum and maximum liquidus temperatures, the viscosity range of the liquidus was calculated.

The resistivity of the glass was measured during viscosity measurements at high temperature on a 1 cm thickness of molten glass using an RLC bridge. The resistivity measured at the temperature at which the viscosity is 30 Pa.s (ρ (30 Pa.s)) is given in the tables.

The ceramming cycles carried out in a static furnace (in ambient air atmosphere) are specified below:

KV1:
heating up to 750° C. at a heating rate of 10° C./min;
holding at this temperature (= 750° C.) for 24 minutes;
temperature rise from 750° C. to 860° C. at a heating rate of 10° C./min;
holding at this temperature (= 860° C.) for 10 minutes;
cooling to ambient temperature at a rate depending on the inertia of the oven.

The total duration of this cycle is 118 min (excluding cooling).

KV 19:
heating up to 800° C. at a heating rate of 10° C./min;
holding at this temperature (= 800° C.) for 24 minutes;
temperature rise from 800° C. to 860° C. at a heating rate of 10° C./min;
holding at this temperature (= 860° C.) for 10 minutes;
cooling to ambient temperature at a rate depending on the inertia of the oven.

The total duration of this cycle is 118 min (excluding cooling).

Industrially it is believed that these cycles could be significantly shorter as a much higher rate of temperature rise to 750° C. could probably be achieved, especially if the ceramming is carried out in a roller earth.

A35:
rapid rise in temperature up to 500° C.,
temperature rise from 500 to 650° C., at a heating rate of 23° C./min,
temperature rise from 650° C. to 820° C., at a heating rate of 6.7° C./min,
temperature rise from 820° C. to 920° C., at a heating rate of 15° C./min,
holding at this temperature Tmax (= 920° C.) for 7 minutes,
cooling to 850° C. at 35° C./min,
cooling down to ambient temperature at a rate depending on the inertia of the furnace.

Coefficients of thermal expansion (CTEs) were measured with a high-temperature dilatometer (DIL 402C, Netzsch) at a heating rate of 3° C./min on rod-shaped glass-ceramic samples.

On polished 4 mm thick samples, total and diffuse transmission measurements were performed using a Varian spectrophotometer (model Cary 500 Scan), equipped with an integrating sphere. Optical properties such as colorimetric coordinates (x, y), integrated transmission (Y (%)) in the visible range (between 380 and 780 nm) and the level of haze (diffusion or haze (%)) according to ASTM D 1003-13 of Apr. 15, 2013 are given under illuminant D65 with 2° observer. A Y value of less than 10% is recommended, preferably less than 5%, much preferable less than 2%, to conceal the inductors and other technical components arranged under the cooktops. A Y value of at least 0.8% is also recommended. A haze level of less than 12%, preferably less than 6%, more preferably less than 2%, is recommended to ensure good visibility of the light emitted by the LEDs arranged under the cooktops. The colorimetric coordinates (x,y) measured using the EGO Lite TC LED as illuminant have also been reported. Transmission values at 950 nm (T₉₅₀ₙₘ) are also shown in the tables. An optical transmission for a wavelength of 950 nm (T₉₅₀ₙₘ) of between 40 and 70%, and even more preferably between 50 and 70%, which allows the use of infra-red electronic control keys, transmitting and receiving at this wavelength, is also recommended.

X-ray diffraction analyses were performed. The percentages of crystalline phases (expressed as a mass percentage of the total crystallized fraction) were evaluated by a Rietveld method as well as the average size of β-quartz crystallites. In the case of Example 1, the percentage of glassy phase was also determined by a standard addition method. It is 40% by weight after ceramming with KV1 cycle.

Examples 1 to 25 illustrate the present application.

Compositions and properties of the glasses are reported in tables 1-6.

The properties of the resulting glass-ceramics are shown in tables 1- 6 in the case of ceramming with cycle KV1 and in table 7 in the case of ceramming with cycle KV 19. In the case of the P₂O₅ containing glasses, ceramming with the KV 19 cycle leads generally to lower haze than KV 1.

Examples 1 to 6 are the preferred examples because it is with the corresponding glass-ceramics that the light emitted by the white LEDs appears the whitest. Of these, Examples 3, 4, 5 and 6 are particularly preferred because they also have low expansion (≤ 6×10⁻⁷K⁻¹ between 25 and 700° C.) after ceramming with cycles KV1 and therefore could be used with radiant heaters. Example 5 is the most preferred because in addition it displays a visible integrated transmission lower than 2%.

Examples 3, 4 and 5 present the same base glass composition but differ only by their level of Fe₂O₃ and CoO.

Examples A to F (from Table 8) are comparative examples.

In Comparative Example A, the coloring is obtained using chromium and vanadium oxides and their TiO₂ content is less than 3%. Consequently, the colorimetric coordinates are outside the objective.

The Comparative Examples B and C correspond to the same composition with two different ceramming treatments (KV1 and A35). The TiO₂ content of the glass is less than 3%. As a consequence, the transmission, Y, is too high and the colorimetric coordinates outside the objective, regardless of the ceramming cycle.

The Comparative Example D contains a high Li₂O content. As a result, the transmission is relatively high and the color coordinates are outside the objective.

The Comparative Example E contains a low Li₂O content. As a result, the expansion of the glass-ceramic is too high and the color coordinates are outside the objective.

The Comparative Example F does not contain ZrO₂. As a result, the expansion is too high and the haze unacceptable, probably due to insufficient nucleation.

Tables 1 to 7 (Examples 1 to 25 according the present application) and 8 (Comparative Examples A, B, C, D, E and F) are presented below.

TABLE 1

| | | | | |
|---|---|---|---|---|
| Composition (wt %) | 1 | 2 | 3 | 4 |
| SiO₂ | 64.7 | 65.45 | 62.28 | 62.28 |
| P₂O₅ | | | 2.27 | 2.27 |
| Al₂O₃ | 20.34 | 19.68 | 19.06 | 19.06 |
| Li₂O | 2.9 | 2.90 | 2.83 | 2.83 |
| MgO | 0.69 | 1.46 | 0.82 | 0.82 |
| ZnO | 3.19 | 1.96 | 3.1 | 3.1 |
| BaO | 2.47 | 2.77 | 2.68 | 2.68 |
| CaO | 0.44 | 0.44 | 0.97 | 0.97 |
| TiO₂ | 3.36 | 3.43 | 4.5 | 4.5 |
| ZrO₂ | 0.67 | 0.67 | 0.66 | 0.66 |
| Na₂O | 0.61 | 0.61 | 0.2 | 0.2 |
| K₂O | 0.2 | 0.2 | 0.2 | 0.2 |
| SnO₂ | 0.3 | 0.3 | 0.29 | 0.29 |
| Fe₂O₃ | 0.08 | 0.060 | 0.10 | 0.080 |
| CoO | 0.05 | 0.07 | 0.05 | 0.07 |
| (0.74MgO+0.19BaO+0.29SrO+0.53 CaO+0.48Na₂O+0.32K₂O)/Li₂O | 0.54 | 0.76 | 0.63 | 0.63 |

| | | | |
|---|---|---|---|
| T(30 Pa.s) (°C) | 1616 | 1625 | 1578 |
| Resistivity at 30 Pa.s (Ω.cm) | 5 | 4.8 | 5.7 |
| Tliq (°C) | 1280-1300 | 1235-1252 | 1237-1260 |
| Viscosity at Tliq (Pa.s) | 1060-1430 | 2500 - 3300 | 1300-1800 |

| Properties after ceramming with KV1 cycle | | | | |
|---|---|---|---|---|
| CTE(25-700° C.) (× 10⁻⁷/K) | 7.4 | 12.3 | 5.3 | 5.9 |
| CTE(25-300° C.) (× 10⁻⁷/K) | 5.4 | 10 | 4.3 | 5.1 |
| T950nm (%) | 53.7 | 54.7 | 48.5 | 53.2 |
| Illuminant D65 | | | | |
| Y (%) | 1.86 | 1.73 | 2.68 | 2.88 |
| Diffusion (Haze) (%) | 3.05 | 5.1 | 0.9 | 1.5 |
| x | 0.4516 | 0.4503 | 0.4403 | 0.4312 |
| y | 0.3853 | 0.3897 | 0.3905 | 0.385 |
| Illuminant EGO Lite TC | | | | |
| Y (%) | 1.74 | 1.61 | 2.55 | 2.73 |
| x | 0.401 | 0.3975 | 0.3943 | 0.3825 |
| y | 0.3796 | 0.3845 | 0.3833 | 0.3737 |
| X-Ray diffraction | | | | |
| Mean size of β-quartz solid solution crystallites (nm) | 53 | 58 | 48 | |
| β-quartz solid solution (%) | 90 | 96 | 95 | |
| β-Spodumene- (%) | 5 | 4 | 1 | |
| Spinel solid solution (%) | 5 | | 4 | |

TABLE 2

| | | | | |
|---|---|---|---|---|
| Composition (wt %) | 5 | 6 | 7 | 8 |
| SiO₂ | 62.245 | 62.09 | 63.88 | 62.83 |
| P₂O₅ | 2.27 | 2.26 | 2.13 | 2.12 |
| Al₂O₃ | 19.06 | 19.01 | 19.65 | 19.59 |
| Li₂O | 2.83 | 2.82 | 2.64 | 2.63 |
| MgO | 0.82 | 0.82 | 0.39 | 0.39 |
| ZnO | 3.1 | 3.1 | 3.21 | 3.20 |
| BaO | 2.68 | 2.67 | 2.42 | 2.41 |
| CaO | 0.97 | 0.97 | 0.44 | 0.44 |
| TiO₂ | 4.5 | 4.49 | 3.31 | 4.50 |
| ZrO₂ | 0.66 | 0.91 | 0.67 | 0.68 |
| Na₂O | 0.2 | 0.2 | 0.60 | 0.59 |
| K₂O | 0.2 | 0.2 | 0.2 | 0.2 |
| SnO₂ | 0.29 | 0.29 | 0.29 | 0.29 |
| Fe₂O₃ | 0.120 | 0.12 | 0.10 | 0.060 |
| CoO | 0.055 | 0.055 | 0.07 | 0.07 |
| (0.74MgO+0.19BaO+0.29SrO+0.5 3CaO+0.48Na₂O+0.32K₂O)/Li₂O | 0.63 | 0.63 | 0.51 | 0.50 |
| T(30 Pa.s) (°C) | | | 1638 | |
| Resistivity at 30 Pa.s (Ω.cm) | | | 4.6 | |
| Tliq (°C) | | | 1240-1260 | |
| Viscosity at Tliq (Pa.s) | | | 2600 - 3600 | |

| Properties after ceramming with KV1 cycle | | | | |
|---|---|---|---|---|
| CTE(25-700° C.) (× 10⁻⁷/K) | 5.8 | 6 | 7.6 | 8 |
| CTE(25-300° C.) (× 10⁻⁷/K) | 5.2 | 5.4 | 6.7 | 7.4 |
| T950nm (%) | 43.9 | 49.7 | 52.5 | 60.8 |
| Illuminant D65 | | | | |
| Y (%) | 1.48 | 3 | 1.97 | 3.2 |
| Diffusion (Haze) (%) | 1.42 | 0.8 | 3.4 | 3.02 |
| x | 0.4596 | 0.4445 | 0.449 | 0.4246 |
| y | 0.3985 | 0.3796 | 0.3764 | 0.3864 |
| Illuminant EGO Lite TC | | | | |
| Y (%) | 1.4 | 2.84 | 1.84 | 2.97 |
| x | 0.4125 | 0.3958 | 0.3952 | 0.3697 |
| y | 0.3976 | 0.3713 | 0.3674 | 0.3521 |
| X-Ray diffraction | | | | |
| Mean size of des β-quartz solid solution crystallites (nm) | | | 48 | |
| β-quartz solid solution (%) | | | 94 | |
| β-Spodumene- (%) | | | | |
| Spinel solid solution (%) | | | 6 | |

TABLE 3

| | | | | |
|---|---|---|---|---|
| Composition (wt %) | 9 | 10 | 11 | 12 |
| SiO₂ | 65.13 | 63.61 | 64.475 | 64.945 |
| P₂O₅ | | 2.13 | | |
| Al₂O₃ | 20.41 | 19.65 | 19.54 | 19.81 |
| Li₂O | 2.90 | 2.9 | 2.90 | 3.22 |
| MgO | 1.30 | 0.39 | 1.45 | 1.47 |
| ZnO | 1.96 | 3.21 | 1.95 | 1.98 |
| BaO | 2.48 | 2.41 | 2.75 | 2.78 |
| CaO | 0.44 | 0.44 | 0.44 | 0.45 |
| TiO₂ | 3.43 | 3.32 | 4.62 | 3.45 |
| ZrO₂ | 0.67 | 0.68 | 0.67 | 0.68 |
| Na₂O | 0.61 | 0.6 | 0.61 | 0.62 |
| K₂O | 0.2 | 0.2 | 0.2 | 0.2 |
| SnO₂ | 0.30 | 0.29 | 0.30 | 0.3 |
| Fe₂O₃ | 0.10 | 0.10 | 0.060 | 0.060 |
| CoO | 0.07 | 0.07 | 0.035 | 0.035 |
| (0.74MgO+0.19BaO+0.29SrO+0.5 3CaO+0.48Na₂O+0.32K₂O)/Li₂O | 0.7 | 0.46 | 0.75 | 0.69 |

| T(30 Pa.s) (°C) | | | 1597 | 1610 |
|---|---|---|---|---|
| Resistivity at 30 Pa.s (Ω.cm) | | | 5.3 | 4.3 |
| Tliq (°C) | | | 1244-1260 | 1225-1244 |
| Viscosity at Tliq (Pa.s) | | | 1500-2000 | 2300-3100 |
| Properties after ceramming with KV1 cycle | | | | |
| CTE(25-700° C.) (× 10⁻⁷/K) | 12.3 | 3.5 | 13.3 | 9.9 |
| CTE(25-300° C.) (× 10⁻⁷/K) | 10.5 | 2.4 | 11.6 | 7.5 |
| T950nm (%) | 55.3 | 50.3 | 55.4 | 47.7 |
| Illuminant D65 | | | | |
| Y (%) | 1.81 | 1.67 | 2.73 | 1.83 |
| Diffusion (Haze) (%) | 4.01 | 2.51 | 2.05 | 3.1 |
| x | 0.4477 | 0.4586 | 0.4392 | 0.4373 |
| y | 0.3527 | 0.3823 | 0.3971 | 0.4215 |
| Illuminant EGO Lite TC | | | | |
| Y (%) | 1.66 | 1.55 | 2.61 | 1.77 |
| x | 0.3863 | 0.4057 | 0.3949 | 0.399 |
| y | 0.3379 | 0.3763 | 0.4004 | 0.4209 |
| X-Ray diffraction | | | | |
| Mean size of des β-quartz solid solution crystallites (nm) | | 50 | | |
| β-quartz solid solution (%) | | 98 | | |
| β-Spodumene- (%) | | 2 | | |
| Spinel solid solution (%) | | | | |

TABLE 4

| | | | | |
|---|---|---|---|---|
| Composition (wt %) | 13 | 14 | 15 | 16 |
| SiO₂ | 64.065 | 64.045 | 63.845 | 62.70 |
| P₂O₅ | | | | 2.26 |
| Al₂O₃ | 19.60 | 19.60 | 19.54 | 19.16 |
| Li₂O | 2.91 | 2.91 | 2.90 | 2.85 |
| MgO | 1.15 | 1.15 | 0.84 | 1.42 |
| ZnO | 2.58 | 2.58 | 3.19 | 1.92 |
| BaO | 2.75 | 2.75 | 2.75 | 2.69 |
| CaO | 0.44 | 0.44 | 0.44 | 0.97 |
| TiO₂ | 4.63 | 4.63 | 4.62 | 4.53 |
| ZrO₂ | 0.67 | 0.67 | 0.67 | 0.66 |
| Na₂O | 0.62 | 0.61 | 0.61 | 0.20 |
| K₂O | 0.2 | 0.2 | 0.2 | 0.20 |
| SnO₂ | 0.3 | 0.3 | 0.30 | 0.29 |
| Fe₂O₃ | 0.060 | 0.080 | 0.060 | 0.10 |
| CoO | 0.035 | 0.035 | 0.035 | 0.05 |
| (0.74MgO+0.19BaO+0.29SrO+0.5 3CaO+0.48Na₂O+0.32K₂O)/Li₂O | 0.68 | 0.67 | 0.60 | 0.79 |

| T(30 Pa.s) (°C) | 1585 | | | |
|---|---|---|---|---|
| Resistivity at 30 Pa.s (Ω.cm) | 5.3 | | | |
| Tliq (°C) | 1240-1280 | | | |
| Viscosity at Tliq (Pa.s) | 1000-1900 | | | |
| Properties after ceramming with KV1 cycle | | | | |
| CTE(25-700° C.) (× 10⁻⁷/K) | 11.6 | 12.3 | 10.2 | 9.8 |
| CTE(25-300° C.) (× 10⁻⁷/K) | 9.6 | 10.3 | 8 | 8.8 |
| T950nm (%) | 51.6 | 43.1 | 46.4 | 59.5 |
| Illuminant D65 | | | | |
| Y (%) | 2.23 | 0.86 | 1.46 | 6.32 |
| Diffusion (Haze) (%) | 3.02 | 2.3 | 4.25 | 0.41 |
| x | 0.4465 | 0.471 | 0.4591 | 0.4102 |
| y | 0.4211 | 0.424 | 0.4341 | 0.3557 |
| Illuminant EGO Lite TC | | | | |
| Y (%) | 2.15 | 0.82 | 1.41 | 6.04 |
| x | 0.4072 | 0.4296 | 0.4223 | 0.3626 |
| y | 0.4231 | 0.4341 | 0.4434 | 0.3386 |

TABLE 5

| | | | | |
|---|---|---|---|---|
| Composition (wt %) | 17 | 18 | 19 | 20 |
| SiO₂ | 62.655 | 64.69 | 64.69 | 64.66 |
| P₂O₅ | 2.24 | | | |
| Al₂O₃ | 19.15 | 20.34 | 20.34 | 20.34 |
| Li₂O | 2.85 | 2.90 | 2.90 | 2.90 |
| MgO | 1.42 | 0.68 | 0.68 | 0.69 |
| ZnO | 1.91 | 3.19 | 3.19 | 3.19 |
| BaO | 2.69 | 2.47 | 2.47 | 2.47 |
| CaO | 0.97 | 0.44 | 0.44 | 0.44 |
| TiO₂ | 4.53 | 3.36 | 3.36 | 3.36 |
| ZrO₂ | 0.66 | 0.67 | 0.67 | 0.67 |
| Na₂O | 0.20 | 0.61 | 0.61 | 0.61 |
| K₂O | 0.20 | 0.2 | 0.2 | 0.2 |
| SnO₂ | 0.29 | 0.3 | 0.3 | 0.3 |
| Fe₂O₃ | 0.20 | 0.08 | 0.10 | 0.10 |
| CoO | 0.035 | 0.07 | 0.05 | 0.07 |
| (0.74MgO+0.19BaO+0.29SrO+0.5 3CaO+0.48Na₂O+0.32K₂O)/Li₂O | 0.78 | 0.54 | 0.54 | 0.54 |

| Properties | | | | |
|---|---|---|---|---|
| T(30 Pa.s) (°C) | | | | |
| Resistivity at 30 Pa.s (Ω.cm) | | | | |
| Tliq (°C) | | | | 1284 - 1300 |
| Viscosity at Tliq (Pa.s) | | | | |
| Properties after ceramming with KV1 cycle | | | | |
| CTE(25-700° C.) (× 10⁻⁷/K) | 9.5 | 7.9 | 8.1 | 8.4 |
| CTE(25-300° C.) (× 10⁻⁷/K) | 8.7 | 5.9 | 6.1 | 6.2 |
| T950nm (%) | 45.8 | 50.7 | 48.2 | 49.3 |
| Illuminant D65 | | | | |
| Y (%) | 3.03 | 0.92 | 1.03 | 0.81 |
| Diffusion (Haze) (%) | 0.48 | 3.18 | 3.25 | 3.25 |
| x | 0.4697 | 0.4726 | 0.4778 | 0.4786 |
| y | 0.3865 | 0.3757 | 0.3931 | 0.3864 |
| Illuminant EGO Lite TC | | | | |
| Y (%) | 2.87 | 0.84 | 0.95 | 0.74 |
| x | 0.4226 | 0.413 | 0.4264 | 0.4216 |
| y | 0.3858 | 0.3723 | 0.3964 | 0.3386 |
| Diffraction X | | | | |
| Mean size of des β-quartz solid solution crystallites | | | | 55 |
| β-quartz solid solution (%) | | | | 91 |
| β-Spodumene- (%) | | | | 4 |
| Spinel solid solution (%) | | | | 5 |

TABLE 6

| | | | | | |
|---|---|---|---|---|---|
| Composition (wt %) | 21 | 22 | 23 | 24 | 25 |
| SiO₂ | 64.33 | 62.30 | 61.49 | 61.025 | 60.815 |
| ₂O₅ | | 2.25 | 1.06 | 2.26 | 2.25 |
| Al₂O₃ | 20.34 | 19.04 | 20.84 | 20.41 | 20.39 |
| Li₂O | 2.90 | 2.83 | 2.87 | 2.81 | 2.81 |
| MgO | 0.69 | 0.82 | 0.83 | 0.81 | 0.81 |
| ZnO | 3.19 | 3.10 | 3.15 | 3.08 | 3.08 |
| BaO | 2.47 | 2.67 | 2.71 | 2.65 | 2.65 |
| CaO | 0.44 | 0.97 | 0.98 | 0.97 | 0.97 |
| TiO₂ | 3.36 | 4.50 | 4.56 | 4.47 | 4.46 |
| ZrO₂ | 1 | 0.66 | 0.67 | 0.65 | 0.90 |
| Na₂O | 0.61 | 0.20 | 0.20 | 0.20 | 0.20 |
| K₂O | 0.2 | 0.20 | 0.20 | 0.20 | 0.20 |
| SnO₂ | 0.3 | 0.29 | 0.29 | 0.29 | 0.29 |
| Fe₂O₃ | 0.10 | 0.10 | 0.10 | 0.12 | 0.12 |
| CoO | 0.07 | 0.070 | 0.050 | 0.055 | 0.055 |
| (0.74MgO+0.19BaO+0.29 SrO+0.53CaO+0.48Na₂O+ 0.32K₂O)/Li₂O | 0.54 | 0.63 | 0.63 | 0.63 | 0.63 |

| Properties after ceramming with KV1 cycle | | | | | |
|---|---|---|---|---|---|
| CTE(25-700° C.) (× 10⁻⁷/K) | 7.5 | 5.8 | 10.4 | 8.1 | 8 |
| CTE(25-300° C.) (× 10⁻⁷/K) | 5.2 | 5.1 | 8.9 | 7 | 6.9 |
| T950nm (%) | 61.9 | 51.6 | 48.6 | 48.5 | 50.6 |
| Illuminant D65 | | | | | |
| Y (%) | 4.18 | 2.65 | 1.32 | 1.7 | 2.3 |
| Diffusion (Haze) (%) | 2.43 | 1.1 | 1.51 | 1 | 0.6 |
| x | 0.4334 | 0.4318 | 0.4667 | 0.4579 | 0.4538 |
| y | 0.3288 | 0.3741 | 0.3965 | 0.3779 | 0.369 |
| Illuminant EGO Lite TC | | | | | |
| Y (%) | 3.85 | 2.5 | 1.23 | 1.58 | 2.16 |
| x | 0.373 | 0.3803 | 0.4168 | 0.4049 | 0.3999 |
| y | 0.3097 | 0.3606 | 0.3984 | 0.3726 | 0.3612 |

TABLE 7

properties of glass-ceramics after ceramming with cycle K19

| Example | 3 | 4 | 5 | 6 | 22 | 24 | 25 |
|---|---|---|---|---|---|---|---|
| CTE(25-700° C.) (× 10⁻⁷/K) | 6.1 | 5.9 | 6.1 | | 5.8 | | |
| CTE(25-300° C.) (× 10⁻⁷/K) | 5.5 | 5.2 | 5.4 | | 5.2 | | |
| T950nm (%) | 46.8 | 53.1 | 43.9 | 47.7 | 50.8 | 46 | 47.7 |
| Illuminant EGO Lite TC | | | | | | | |
| Y (%) | 2.18 | 2.8 | 1.55 | 2.43 | 2.32 | 1.2 | 1.5 |
| x | 0.3985 | 0.3787 | 0.4068 | 0.3995 | 0.3826 | 0.412 | 0.4114 |
| y | 0.392 | 0.3707 | 0.3945 | 0.3803 | 0.3659 | 0.3817 | 0.3738 |
| Illuminant D65 | | | | | | | |
| Y (%) | 2.2 | 2.98 | 1.64 | 2.56 | 2.46 | 1.3 | 1.64 |
| Diffusion (Haze) (%) | 0.4 | 0.7 | 0.7 | 0.4 | 0.6 | 0.7 | 0.4 |
| x | 0.4436 | 0.4273 | 0.4536 | 0.4472 | 0.4335 | 0.4645 | 0.465 |
| y | 0.3971 | 0.3834 | 0.3973 | 0.3866 | 0.3782 | 0.3841 | 0.3776 |
| Diffraction X | | | | | | | |
| Mean size of des β-quartz solid solution crystallites (nm) | 44 | | | | | | |
| β-quartz solid solution (%) | 95 | | | | | | |
| β-Spodumene-(%) | 1 | | | | | | |
| Spinel solid solution (%) | 4 | | | | | | |

TABLE 8

| Composition (wt %) | A | B | C | D | E | F |
|---|---|---|---|---|---|---|
| SiO₂ | 63.84 | 64.54 | 64.54 | 64.81 | 65.58 | 66.1 |
| P₂O₅ | 2.12 | | | | | |
| Al₂O₃ | 19.52 | 20.34 | 20.34 | 20.8 | 20.41 | 19.68 |
| Li₂O | 2.62 | 2.9 | 2.9 | 3.74 | 2.45 | 2.52 |
| MgO | 0.39 | 0.69 | 0.69 | 0.37 | 1.30 | 1.46 |
| ZnO | 3.2 | 3.19 | 3.19 | 1.53 | 1.96 | 1.97 |
| BaO | 2.41 | 2.47 | 2.47 | 2.48 | 2.48 | 2.77 |
| CaO | 0.44 | 0.44 | 0.44 | 0.46 | 0.44 | 0.46 |
| TiO₂ | 2.85 | 2.85 | 2.85 | 3.84 | 3.43 | 3.86 |
| ZrO₂ | 1.35 | 1.3 | 1.3 | 0.7 | 0.67 | |
| Na₂O | 0.59 | 0.61 | 0.61 | 0.6 | 0.61 | 0.61 |
| K₂O | 0.2 | 0.2 | 0.2 | 0.2 | 0.2 | 0.2 |
| SnO₂ | 0.29 | 0.3 | 0.3 | 0.3 | 0.3 | 0.3 |
| Fe₂O₃ | 0.12 | 0.1 | 0.1 | 0.1 | 0.1 | |
| CoO | / | 0.07 | 0.07 | 0.07 | 0.07 | 0.07 |
| V₂O₅ | 0.04 | | | | | |
| Cr₂O₃ | 0.02 | | | | | |
| (0.74MgO+0.19BaO+0.29SrO +0.53CaO+0.48Na₂O+0.32K₂ O)/Li₂0 | 0.48 | 0.52 | 0.52 | 0.34 | 0.80 | 0.85 |
| cycle | A35 | A35 | KV1 | KV1 | KV1 | KV1 |
| Properties | | | | | | |
| CTE(25-700° C.) (× 10⁻⁷/K) | 3.3 | 3.7 | | | 25.4 | 33.8 |
| CTE(25-300° C.) (× 10⁻⁷/K) | 3.1 | 1.8 | | | 24.5 | 32.6 |
| Illuminant D65 | | | | | | |
| Y (%) | 0.87 | 16.2 | 10.52 | 5.62 | 9.2 | 3.87 |
| Diffusion (Haze) (%) | 1.01 | 0.54 | 3.03 | 0.43 | 8.2 | 26.94 |
| x | 0.6068 | 0.3212 | 0.3875 | 0.3936 | 0.3529 | 0.3985 |
| y | 0.3763 | 0.2253 | 0.2755 | 0.291 | 0.3509 | 0.4133 |
| Illuminant EGO Lite TC | | | | | | |
| Y (%) | | 15.34 | 9.72 | 5.19 | | |
| x | | 0.2791 | 0.3376 | 0.3337 | | |
| y | | 0.2031 | 0.2628 | 0.2635 | | |
| Diffraction X | | | | | | |
| Mean size of β-quartz solid solution crystallites (nm) | | | | | 60 | |
| β-quartz solid solution (%) | | | | | 93 | |
| β-Spodumene- (%) | | | | | | |
| Spinel solid solution (%) | | | | | 7 | |

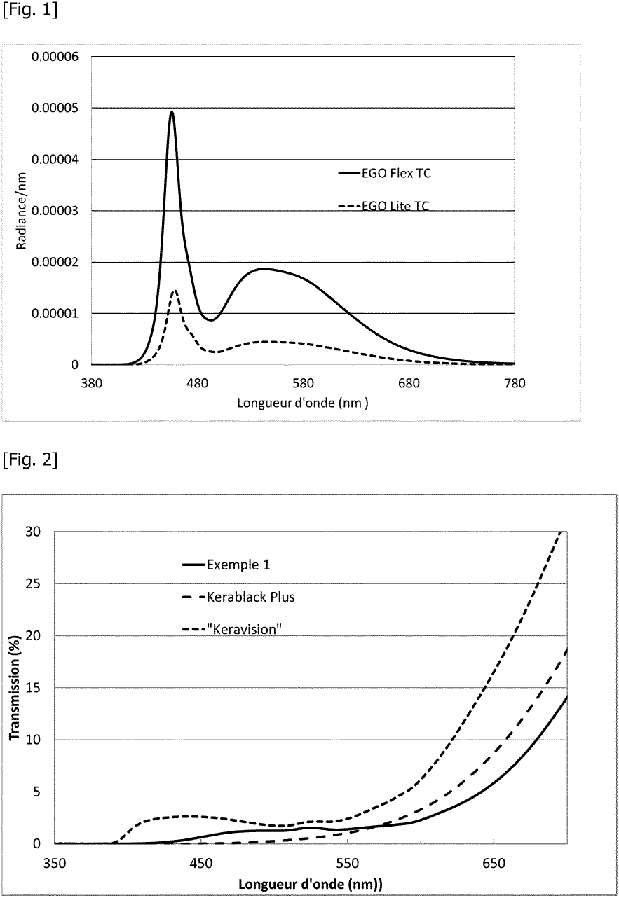

FIG. 1 shows that commercially available white LEDs have two emission bands, a fairly bright band between 430 and 480 nm and a less bright band between 480 and 700 nm.

Consequently, to let the light emitted by white LEDs pass through, significant transmission is required in both areas. Thus, it is not possible to use vanadium oxide which leads to high absorption between about 400 and 550 nm and very low absorption above 550 nm. It is preferable not to use chromium oxide which leads to strong absorption between 400 and 450 nm.

FIG. 2 shows the transmission curve of Example 1 of the invention in comparison with the two commercial materials Kerablack Plus® and KeraVision®. The transmission of Example 1 is significantly more constant between 430 and 600 nm than those of the other two materials.

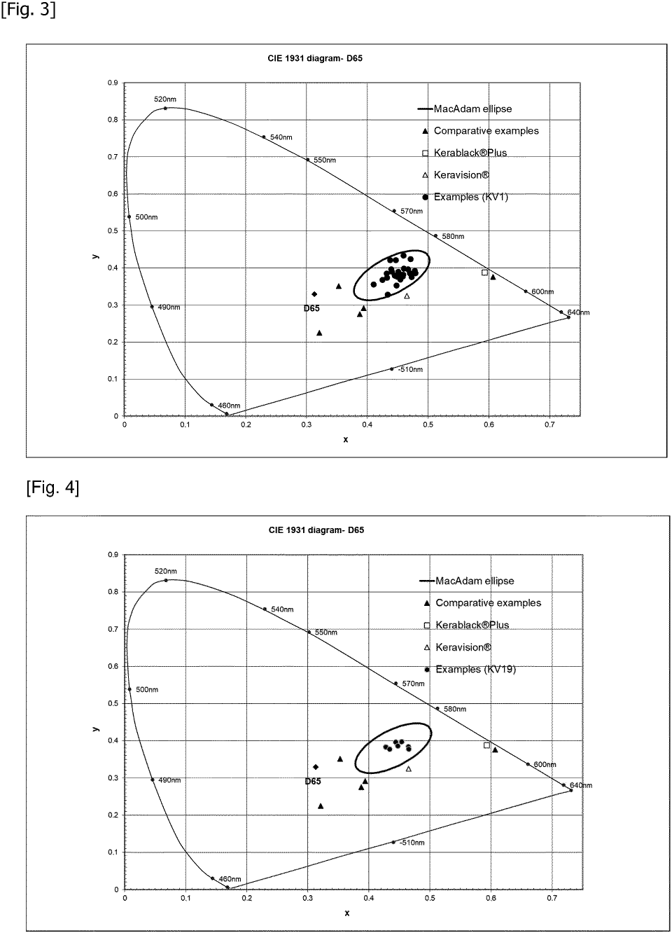

FIG. 3 shows the colorimetric coordinates y as a function of x according to the CIE 1931 - D65 diagram of glass-ceramics according to the invention (Examples 1 to 25 after ceramming with cycle KV1). These coordinates are indicated by black circles. These circles lie within the MacAdam ellipse described above. The glass-ceramics of the invention meet the color requirements. The two glass-ceramics marketed by Eurokera, Kerablack® plus (colored with V₂O₅, Fe₂Oₛ and Cr₂O₃, which allow the transmission of red LEDs) and KeraVision® (colored with CoO, Fe₂O₃ and V₂O₅, which allow the transmission of blue LEDs) do not meet these requirements. The colorimetric coordinates of the comparative examples A, B, C, D and E are also indicated and are outside the objective.

FIG. 4 shows the colorimetric coordinates y as a function of x according to the CIE 1931 - D65 diagram of glass-ceramics according to the invention (Examples 3, 4, 5, 6, 22, 24, 25 after ceramming with cycle KV19). These coordinates are indicated by black circles. These circles lie within the MacAdam ellipse described above.

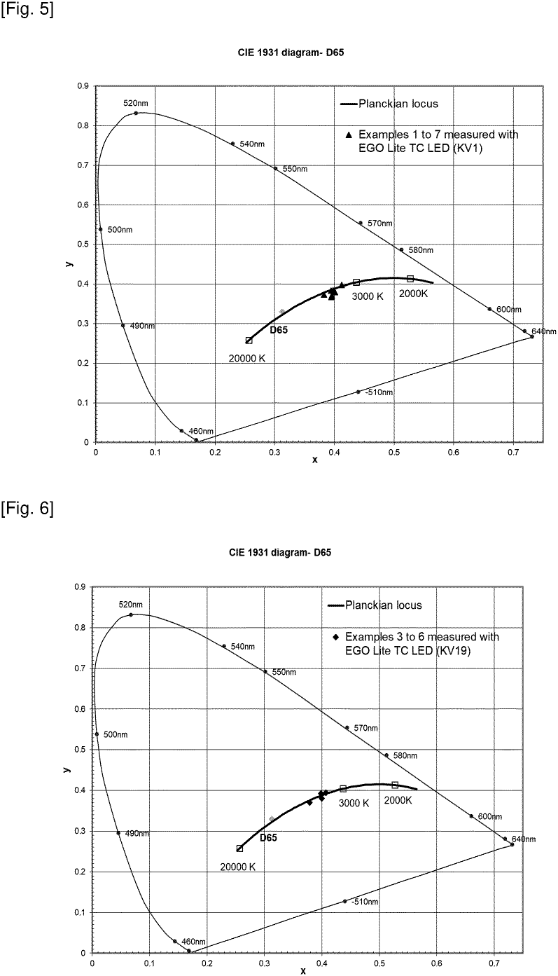

FIG. 5 shows in a CIE 1931 - D65 diagram the Planckian locus and the color coordinates (x, y) of the preferred examples of the invention (examples 1 to 7) cerammed with cycle KV1 measured with the EGO Lite TC LED as illuminant. FIG. 6 shows in a CIE 1931 - D65 diagram the Planckian locus and the color coordinates (x, y) of preferred examples of the invention (examples 3 to 6) cerammed with cycle KV19 measured with the EGO Lite TC LED as illuminant.

1. A transparent lithium aluminosilicate (LAS) glass-ceramic containing a β-quartz solid solution as the main crystalline phase, the composition of which, expressed in percentages by mass of oxides, contains:
60 to 67.5% SiO₂,
18 to 22% Al₂O₃,
2.5 to 3.3% Li₂O,
0 to 1.5% MgO,
1 to 3.5% ZnO,
0 to 4% BaO,
0 to 4% SrO,
0 to 2% CaO,
3.1 to 5% TiO₂,
0.4 to 1.3% ZrO₂,
0 to 1% Na₂O,
0 to 1% K₂O,
0 to 3% P₂O₅,
0.02 to 0.1% CoO
0.05 to 0.25% Fe₂O₃
with (0.74 MgO + 0.19 BaO + 0.29 SrO + 0.53 CaO + 0.48 Na₂O + 0.32 K₂O) / Li₂O < 0.8,
and optionally up to 2% of at least one refining agent,
the composition being free of V₂O₅ with the exception of unavoidable traces.

2. The glass-ceramic as claimed in claim 1, the composition of which contains 2.5 to 3% Li₂O.

3. The glass-ceramic as claimed in claim 1, the composition of which contains at least 0.5% P₂O₅, advantageously from 1 to 3% P₂O₅.

4. The glass-ceramic as claimed in claim 1, the composition of which is free, with the exception of unavoidable traces, of B₂O₃.

5. The glass-ceramic as claimed in claim 1, the composition of which, free from unavoidable traces of As₂O₃ and Sb₂O₃, contains SnO₂ as refining agent, advantageously from 0.05% to 0.6% of SnO₂, very advantageously from 0.15% to 0.4% of SnO₂.

6. The glass-ceramic as claimed in claim 1, having a composition of 0.05% to 0.15% Fe₂O₃.

7. The glass-ceramic as claimed in claim 1, characterized in that it has a coefficient of thermal expansion between ±14×10⁻ ⁷K⁻¹, between 25 and 700° C.

8. The glass-ceramic as claimed in claim 1, characterized in that it has
for a thickness of 1 to 8 mm, advantageously 2 to 5 mm, in particular 4 mm, an integrated visible transmission Y, of at least 0.8% but less than 10%, advantageously at least 0.8% but less than 5% and/or;
for a thickness of 1 to 8 mm, advantageously 2 to 5 mm, in particular 4 mm, an optical transmission at a wavelength of 950 nm T₉₅₀ₙₘ of between 40 and 70%, preferably between 50 and 70%, and/or;
a percentage of diffusion of less than 12%, advantageously less than 6%, more advantageously less than 2%, and/or
in transmission colorimetric coordinates, in the CIExy space, for a D65 illuminant with a 2° observer, which are within the twelfth MacAdam ellipse having as center the point with the following trichromatic coordinates x=0.44 y=0.38 Y=1.8%.

9. The glass-ceramic as claimed in claim 1, characterized in that the composition of which, expressed in percentages by mass of oxides, contains:
1.5 to 3% P₂O₅,
18 to 20% Al₂O₃,
2.7 to 3% Li₂O
with (0.74 MgO + 0.19 BaO + 0.29 SrO + 0.53 CaO + 0.48 Na₂O + 0.32 K₂O) / Li₂O < 0.7
and in that it has a coefficient of thermal expansion between ±6×10⁻⁷K⁻¹, between 25 and 700° C.

10. An article, consisting at least in part of a glass-ceramic as claimed in claim 1, chosen in particular from a cooking plate and a glazing.

11. Use of a glass-ceramic as claimed in claim 1, as a substrate for an element selected from a cooking plate and a glass pane.

12. A lithium aluminosilicate glass, a precursor of a glass-ceramic as claimed in claim 1, the composition of which makes it possible to obtain a glass-ceramic as claimed in claim 1.

13. The glass as claimed in claim 12, having:
a liquidus temperature of less than 1400° C. and/or
a liquidus viscosity of more than 400 Pa.s, preferably more than 700 Pa.s and/or
a viscosity of 30 Pa.s at a temperature of at most 1640° C., preferably at a temperature of at most 1630° C. and/or
an electrical resistivity at a viscosity of 30 Pa.s of less than 50 Ωcm, preferably less than 20 Ωcm.

14. A process for producing an article as claimed in claim 10, comprising successively:
melting a vitrifiable raw material feedstock, followed by refining the resulting molten glass;
cooling the refined molten glass obtained and simultaneously shaping it to the desired shape for the article; and
ceramming heat treatment of said shaped glass;
characterized in that said feedstock has a composition which makes it possible to obtain a glass-ceramic having the mass composition stated in claim 1 and in that the ceramming temperature is at most 900° C.

15. The process as claimed in claim 14, characterized in that said vitrifiable raw material feedstock, which is free except for unavoidable traces of As₂O₃ and Sb₂O₃, contains SnO₂ as refining agent, advantageously from 0.05 to 0.6% SnO₂.
